(19) United States
(12) Patent Application Publication
(10) Pub. No.: US 2007/0038522 A1
(43) Pub. Date: Feb. 15, 2007

(54) Auto buying system and method

(75) Inventors: Ryan Bell, Addison, TX (US); Charles Kim, Highland Village, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/405,489

(22) Filed: Apr. 18, 2006

Related U.S. Application Data
(60) Provisional application No. 60/706,437, filed on Aug. 9, 2005.

(51) Int. Cl. G06Q 30/00

(52) U.S. Cl. 705/26

(57) ABSTRACT

Embodiments consistent with the invention relate to a computer-implemented method for providing an offer for a vehicle desired by a customer at a discounted price. The method may comprise receiving a vehicle request from the customer including characteristics of the vehicle desired by the customer and a location associated with the customer, electronically transmitting contact data associated with the customer to a dealer associated with the vehicle desired by the customer, and electronically sending a confirmation of an offer to provide the desired vehicle at the discounted price to the customer, wherein the confirmation does not include pricing information associated with the vehicle.

### CROSS REFERENCE TO RELATED APPLICATION

This application claims priority under 35 U.S.C. § 119 to U.S. Provisional Application No. 60/706,437, filed on Aug. 9, 2005, which is expressly incorporated herein by reference in its entirety.

### TECHNICAL FIELD

The present invention generally relates to computer-implemented systems and methods for facilitating the purchase of products, such as vehicles. Moreover, the invention relates to systems and methods for providing incentives, such as discounted pricing, to customers buying automobiles or other products.

### BACKGROUND

Financial institutions have been very competitive in the last ten years. This is beneficial to customers because a competitive marketplace drives down prices as financial institutions, such as commercial banks, mortgage bankers, credit card issuers and other lenders, attempt to increase their market share by offering better financial products or incentives than their competitors.

For example, a financial institution may offer low interest credit cards or loans to customers in hopes that they will transfer their credit card or loan balances from other financial institutions to the offered credit cards or loans. The same is true for offers or incentives on other types of financial products, such as mortgages, automobile loans, or any other type of customer loan.

In addition, other incentives have been implemented, such as reward programs that provide points, cash-back payments or other rewards based on purchases made by a customer or credit cardholder. Such programs are generally seen as an effective way to maintain customers and reduce attrition to competitors.

In a similar manner, financial institutions have established relationships with merchants or vendors to provide incentives to their customers. For example, banks and credit card issuers may offer special points or rewards to their customers for purchases made with particular merchants or vendors. In some cases, special offers may be presented to customers, such as the ability to purchase products or services at a discount from a merchant or vendor. These offers may be presented in various formats, such as in a mailed flyer or monthly billing statement. Customers may then evaluate these offers and decide on whether to purchase the product or service at the specific price presented in the offer.

While such solutions exist, several drawbacks exist with these conventional methods. For example, rewards cards provide points or incentives to participating customers, but many times require a customer to make considerable purchases before the benefits of such rewards can be realized. In other words, customers often need to spend a considerable amount of money on purchases in order to obtain a sufficient quantity of points or awards. Many times, customers will not redeem their points or otherwise loose interest in the incentives and, thus, never fully realize the benefits.

Another problem that exists is that many merchants provide matching deals or promotions, whereby the merchant agrees to match any offer a potential customer has received. For example, credit cardholders that receive offers to purchase products or services at discounted prices may take these offers to other merchants to obtain the same product or service at a discounted price. In these cases, the financial institution providing the incentive may lose referral fees. Additionally, or alternatively, the costs associated with offering the discounted products or services may need to be absorbed by the financial institution.

In addition, financial institutions have had difficulties in providing incentives or forging relationships with merchants in specific markets. For example, in the automotive sales market, fewer purchases are made by individual customers. Also, the purchase price is magnitudes higher than the average sales price of consumer products. These factors make it difficult for financial institutions, such as credit card issuers, to offer traditional incentives, including reward points. This leads to missed partnering opportunities, as well as lost referral fees.

In view of the foregoing, a need exists for improved systems and methods for providing incentives to customers, including incentives to attract or retain customers. There is also a need for such system and methods that can be applied to a wider array of market segments, such as the automotive sales market. Incentives are needed that do not require customers to make a high level or number of purchases to qualify or receive the full benefit of the promoted incentive or reward. Additionally, a need exists for providing discounted prices for products and/or services, whereby such incentives attract or retain customers, as well as improve the likelihood of receiving referral fees.

### SUMMARY

Accordingly, embodiments consistent with the present invention relate to systems and methods that may alleviate one or more of the above-described limitations or disadvantages existing in the related art.

Embodiments consistent with the invention include computer-implemented systems and methods that provide incentives and facilitate the purchase of products, such as automobiles. Embodiments consistent with the invention also relate to systems and methods for providing incentives, such as discounted pricing, to customers buying automobiles or other products.

In accordance with one embodiment, a computer-implemented method is provided. As disclosed herein, the method may be implemented for providing an offer for a vehicle desired by a customer at a discounted price. The method may comprise receiving a vehicle request from the customer including characteristics of the vehicle desired by the customer and a location associated with the customer, electronically transmitting contact data associated with the customer to a dealer associated with the vehicle desired by the customer, and electronically sending a confirmation of an offer to provide the desired vehicle at the discounted price to the customer, wherein the confirmation does not include pricing information associated with the vehicle.

Embodiments consistent with the invention also relate to a computer-implemented system for providing an offer for a vehicle desired by a customer at a discounted price. The system may comprise means for receiving a vehicle request from the customer including characteristics of the vehicle desired by the customer and a location associated with the customer, means for electronically transmitting contact data associated with the customer to a dealer associated with the vehicle desired by the customer, and means for electronically sending a confirmation of an offer to provide the desired vehicle at the discounted price to the customer, wherein the confirmation does not include pricing information associated with the vehicle.

Embodiments consistent with another aspect of the invention also relate to a computer-implemented method for providing a discount price for a vehicle desired by a customer. The method may comprise receiving a vehicle identification number associated with the vehicle at a dealer, electronically sending the vehicle identification number over a network, electronically receiving data reflecting characteristics of the vehicle, and electronically receiving a confirmation from the customer and sending the confirmation over the network. The method may further comprise receiving data reflecting the discount price for the vehicle, electronically presenting the data reflecting the discount price to the customer, and receiving a selection of a method of payment for purchasing the vehicle at the discount price from the customer.

Embodiments consistent with yet another aspect of the invention also relate to a computer-implemented system for providing a discount price for a vehicle desired by a customer. The system may comprise means for receiving a vehicle identification number associated with the vehicle at a dealer, means for electronically sending the vehicle identification number over a network, means for electronically receiving data reflecting characteristics of the vehicle, and means for electronically receiving a confirmation from the customer and sending the confirmation over the network. The system may further comprise means for receiving data reflecting the discount price for the vehicle, means for electronically presenting the data reflecting the discount price to the customer, and means for receiving a selection of a method of payment for purchasing the vehicle at the discount price from the customer.

It is to be understood that both the foregoing general description and the following detailed description are exemplary and explanatory only, and should not be considered restrictive of the scope of the invention, as described. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate embodiments consistent with the invention and together with the description, serve to explain the principles of the invention. In the drawings:

FIG. 1 illustrates an exemplary system environment for implementing embodiments of the present invention;

FIG. 2 illustrates a more detailed diagram of an exemplary buying system consistent with embodiments of the present invention;

FIG. 3 is a flowchart of an exemplary process for providing an offer for a product desired by a customer at a discounted price, consistent with an embodiment of the present invention; and

FIG. 4 is a flowchart of an exemplary process for providing a discounted price for a vehicle, consistent with an embodiment of the present invention.

### DETAILED DESCRIPTION OF THE EMBODIMENTS

Reference will now be made in detail to exemplary embodiments consistent with the invention, examples of which are illustrated in the accompanying drawings. Wherever possible, the same reference numbers will be used throughout the drawings to refer to the same or like parts.

The following detailed description refers to the accompanying drawings. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering or, adding steps to the disclosed methods. Accordingly, the following detailed description does not limit the invention.

Embodiments consistent with the present invention are directed to systems, methods, and computer-readable media for providing incentives to customers and facilitating the purchase of products at a discounted price. Embodiments consistent with the invention may be implemented in various environments, including computer-based environments, such as personal computers, workstations, servers, laptops, personal digital assistants (PDAs), mobile phones, handheld devices, and other computing devices, workstation, networked and other computing-based environments with one or more customers. The present invention, however, is not limited to such examples and embodiments consistent the invention may be implemented with other platforms and in other environments.

By way of example, embodiments consistent with the invention may be implemented using conventional personal computers (PCs), desktops, hand-held devices, multiprocessor computers, pen computers, microprocessor-based or programmable customer electronics devices, minicomputers, mainframe computers, personal mobile computing devices, mobile phones, portable or stationary personal computers, palmtop computers or the like.

The storage media referred to herein symbolize elements that temporarily or permanently store data and instructions. Although storage functions may be provided as part of a computer, memory functions can also be implemented in a network, processors (e.g., cache, register), or elsewhere. Various types of storage mediums can be used to implement features of the invention, such as a read-only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); (c) semiconductor media, like DRAM, SRAM, EPROM, EEPROM, memory stick, and/or by any other media, like paper.

Embodiments consistent with the invention may also include computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, intranets and the Internet (i.e., the World Wide Web). The network may be a wired or a wireless network. To name a few network implementations, the network may be, for example, a local area network (LAN), a wide area network (WAN), a public switched telephone network (PSTN), an Integrated Services Digital Network (ISDN), an infrared (IR) link, a radio link, such as a Universal Mobile Telecommunications System (UMTS), Global System for Mobile Communication (GSM), Code Division Multiple Access (CDMA), or a satellite link.

Transmission protocols and data formats are also known, such as, for example transmission control protocol/internet protocol (TCP/IP), hyper text transfer protocol (HTTP), secure HTTP, wireless application protocol, unique resource locator (URL), unique resource identifier (URI), hyper text markup language (HTML), extensible markup language (XML), extensible hyper text markup language (XHTML), wireless application markup language (WML), Standard Generalized Markup Language (SGML), etc. Such features may be utilized to implement embodiments consistent with the present invention, as disclosed herein.

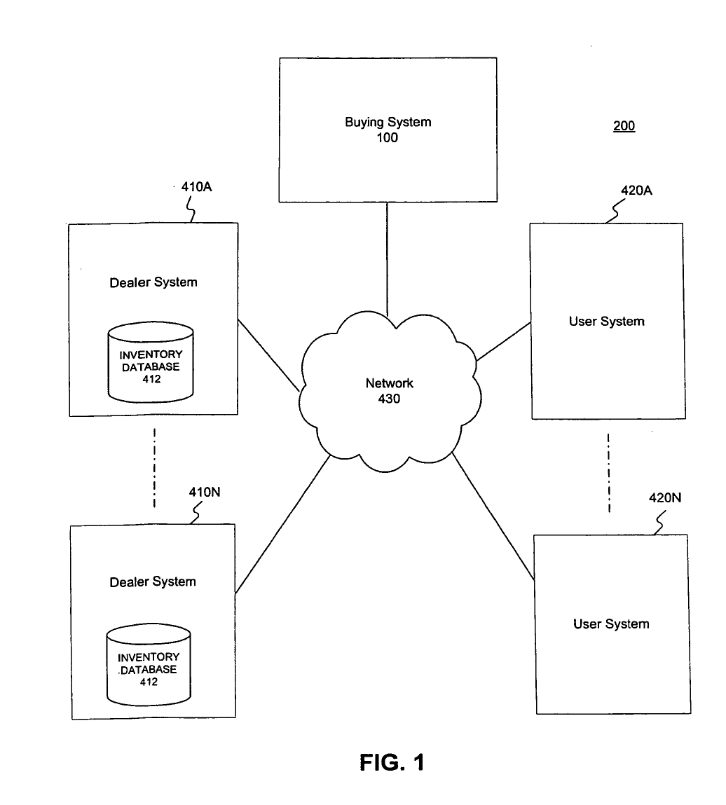

Systems, methods, and computer-readable media consistent with the present invention may provide a customer discounted pricing for the purchase of a product, such as a vehicle. More specifically, systems, methods, and computer readable media consistent with the present invention may obtain characteristics of a desired product by the customer and provide the product to the customer at a discounted price. FIGS. 1-4 illustrate various exemplary embodiments of the invention, wherein the product desired by a customer is a vehicle. Examples of vehicles include automobiles, trucks, vans, motorcycles and the like. One of ordinary skill in the art, however, will appreciate that embodiments of the invention may implemented for any type of product and, thus, are not limited to the sale of vehicles.

FIG. 1 illustrates an exemplary system environment 200 for implementing embodiments of the invention. As shown in FIG. 1, system 200 may comprise multiple computer systems, such as one or more dealer systems 410A-410N, a plurality of user systems 420A-420N (implemented as “clients”) and a buying system 100 (implemented as a “server”). These various components may be connected and communicate with one another through any suitable network 430, including the Internet.

Each of dealer systems 410A-410N may be implemented with a computing system used to perform tasks consistent with embodiments of the invention. In one embodiment, a dealer system may include an inventory database 412 that includes real-time or current records of all inventory maintained by a dealer. Dealer system can be located in any location and may be managed and/or controlled by any dealer providing products for sale. In a preferred embodiment, dealer system can be located at a dealership managed by the dealer.

Additionally, each of dealer systems 410A-410N may provide an interface such that remote systems may be able to collect inventory data from inventory database 412, as needed. For example, each dealer system 410N may provide an interface such that buying system 100 may collect the inventory data periodically over a predetermined time period, such as daily or weekly, and store the inventory data as needed. In the case of a plurality of dealer systems 410A-410N, buying system 100 may interface with each dealer system individually. Alternatively, buying system 100 may interface with an aggregator (not shown) that interfaces individually with each dealer system 410N. By using an aggregator, buying system 100 can be adapted to interface with the aggregator without being adapted to interface with each dealer system 410N.

Each of user systems 420A-420N may comprise any computing system used to perform tasks consistent with embodiments of the invention. In one embodiment, each user system is provided a web interface such that a customer may interact with buying system 100. User system 420N may be located at any location, such as a customer's home, office, kiosk or terminal located at a dealership, etc. Additionally, one skilled in the art will appreciate that any number of user systems may be provided to enable access to system 100 by customers of an entity, such as a financial institution.

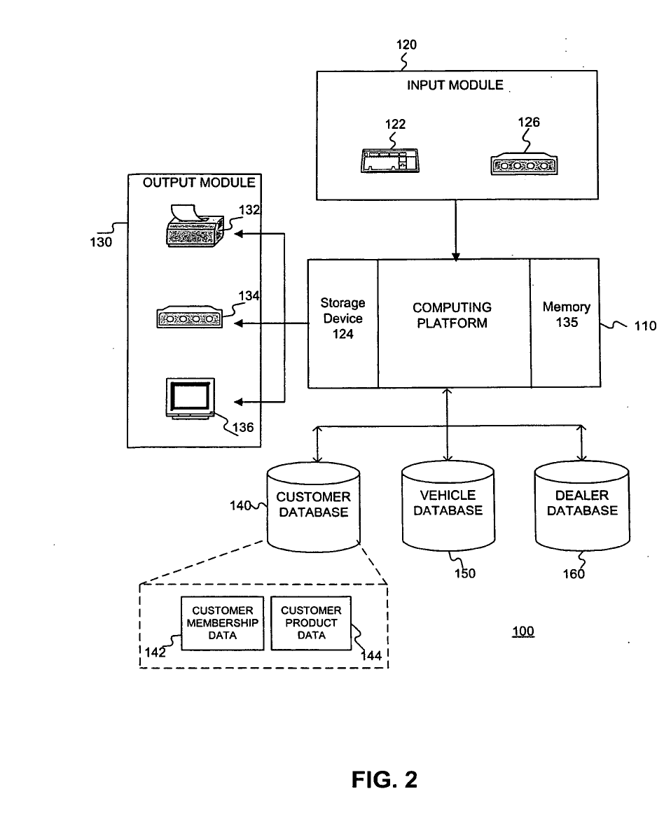

FIG. 2 illustrates a more detailed diagram of an exemplary buying system 100 consistent with embodiments of the present invention. In this example, buying system 100 facilitates the purchasing of vehicles by customers, such as customers of one or more financial institutions. The financial institution(s) may have formed partnerships or other relationships with dealers to provide the discounts to customers of the financial institution(s).

As illustrated in FIG. 2, buying system 100 includes a computing platform 110, an input module 120, an output module 130, a memory 135, a customer database 140, a vehicle database 150, and a dealer database 160. Computing platform 110 may be adapted to process input information received from input module 120. Computing platform 110 may further be adapted to provide output information to output module 130. Additionally, computing platform 110 may access information in customer database 140, vehicle database 150, and dealer database 160 for use in performing methods consistent with the present invention.

Computing platform 110 may comprise a general purpose computer (e.g., a personal computer, network computer, server, or mainframe computer) having a processor that may be selectively activated or reconfigured by a computer program to perform one or more methods consistent with the present invention. Computing platform 110 may also be implemented in a distributed network. Alternatively, computing platform 110 may be specially constructed for carrying-out methods consistent with the present invention.

Input module 120 may include an input device 122 and/or a network interface 126. Input device 122 may be implemented using a keyboard, mouse, speech recognition device, and/or data entering devices. Network interface 126 may receive information over any type of network (not shown), such as a telephony-based network (e.g., PBX or POTS), a local area network, a wide area network, a dedicated intranet, and/or the Internet. Computing platform 110 may also access data stored on storage device 124. Storage device 124 may include a memory, such as RAM or ROM memory, that contains instructions or data for performing one or more methods consistent with the present invention.

In presenting an offer for a discounted price on a vehicle or other product to a customer, input module 120 may be used to enter or obtain characteristics of a product desired by the customer, inventory information regarding the product's availability and/or location, requests by the customer to purchase the product, and pricing information associated with the product. Such information and requests may be obtained, for example, from an employee, from storage device 124, and/or from another computing system via network interface 126. Computing platform 110 may store such information received from input module 120 in customer database 140, vehicle database 150, and/or dealer database 160.

As further described below, computing platform 110 may use the stored customer, vehicle, and dealer information to provide a product chosen by a customer at a discounted price using methods consistent with the present invention. Computing platform 110 also provides notifications to output module 130. Output module 130 in turn outputs product availability, location, and/or price information to interested parties, such as the customer.

Output module 130 may include a printer 132, an output interface 134, and/or a display 136. Printer 132 may be used to provide a printout to interested parties of relevant information, such as pricing information associated with a product, location of the product, confirmation of a special discount price, etc. Output interface 134 may be used to provide such relevant information and/or other information to the interested parties via the Internet, email, fax, page, etc. or save the information on a computer readable medium. Display 136 may be used to provide the pricing, location, and/or other information to interested parties visually.

Customer database 140 may include customer membership data 142 and customer product data 144, as shown in FIG. 2. Customer membership data 142 preferably includes a record of all personal data associated with customers, such as name, address, telephone number, driver's license number, social security number, credit card account number, checking account number, etc. Customer membership data 142 may also include the customer's membership identification (“ID”) and password. Customer product data 144 preferably includes a record of all products and characteristics of the products the customer is interested in purchasing. Customer database may also include credit histories and/or credit ratings associated with the customers. The information to be stored in records 142 and 144 may be entered or obtained using input module 120.

Vehicle database 150 may preferably include a record of all inventory data associated with products, such as the availability of the products, pricing information associated with the products, location of the products, characteristics of the products, identification numbers associated with the products, etc. The information to be stored in vehicle database 150 may be entered or obtained using input module 120. Vehicle database 150 can be updated at a predetermined time, such as every hour, day, week, etc. In one embodiment, vehicle database 150 can be updated by a nightly batch job.

Dealer database 160 includes preferably a record of all dealers participating in an incentive program or other arrangement with the financial institution(s). Dealer database 160 can include data regarding directions to the dealers, all agreements between the dealers and each financial institution, records of all customers sent to dealers to purchase a product at a discounted price, records of fees received from the dealers, sale projections for the dealers, profit margins for the dealers, membership identifiers associated with the dealers, passwords associated with the dealers, etc. The information to be stored in dealer database 160 may be entered or obtained using input module 120.

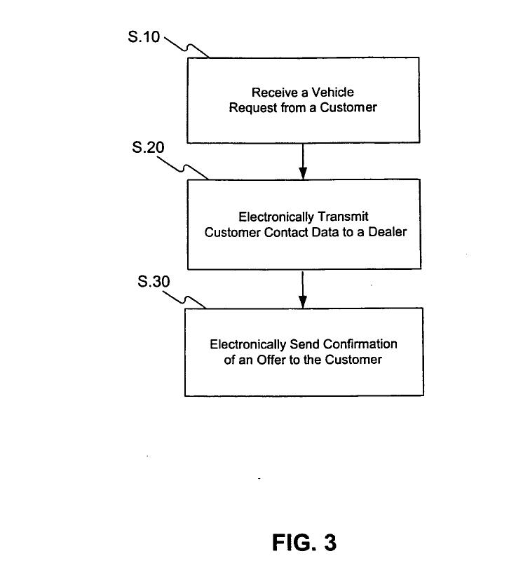

FIG. 3 illustrates a flowchart of an exemplary process for providing an offer for a vehicle or other product desired by a customer at a discounted price. Although the steps of the discounted pricing process are described as being performed in a particular order, one skilled in the art will appreciate that these steps may be performed in a modified or different order, or in an embodiment utilizing less than all of the steps described below. Further, one or more of the steps in FIG. 3 may be performed concurrently or in parallel.

First, computing platform 110 receives a vehicle request from a customer (Step S.10). The customer may specify the characteristics of a vehicle the customer is interested in purchasing using user system 420. For instance, the customer may indicate the model, make, color, etc. of a desired vehicle. The customer may also indicate any desired accessories, such as an audio system, a navigation system, sunroof, etc. The customer additionally may specify a location associated with the customer or desired locale in which to purchase the vehicle. The vehicle request can be submitted in response to offers provided to the customer. For instance, a financial institution may provide an offer to the customer to enroll in an incentive program, such as a vehicle buying program providing discounted or preferred pricing for vehicles. The customer may then enroll in the program and be given a membership ID and/or password that can be stored in customer database 140. The customer may then submit a vehicle request when desired.

In a preferred embodiment, the customer submits the vehicle request using a web page and the request is transmitted to computing platform 110 over the Internet. The web page may be a dedicated web page for a vehicle buying program or other incentive program provided by the financial institution. Special log-ins may also be provided such that only members can submit requests. A skilled artisan will appreciate that the customer can input information regarding the vehicle request using any known input mechanism provided by one or more web pages, such as pull-down menus, text boxes, selection boxes, hyperlinks, and the like.

Next, computing platform 110 electronically transmits customer contact data to dealer system 410 managed by a dealer having the vehicle desired by the customer (Step S.20). As part of this step, computing platform 110 may access customer database 140 to obtain the contact data associated with the customer. Computing platform 110 may also access vehicle database 150 to identify vehicles that match the vehicle request and/or one or more dealers where such vehicles are located. If an exact match is not found, computing platform 110 may obtain data associated with vehicles that most closely match the vehicle requested and/or may send a request to one or more dealers to custom design or order a vehicle matching the vehicle request. Optionally, computing platform 110 may also send a reservation request to dealer system 100 in order to request the dealer to reserve the vehicle for the customer to purchase.

Computing platform 110 may then electronically send a confirmation for the vehicle request to user system 420 controlled by the customer (Step S.30). In one aspect, the confirmation may not include pricing information associated with the vehicle. The confirmation may, however, include information reflecting the location of the dealer having the vehicle matching the vehicle request, directions to the dealer, identification of the matching vehicle (e.g., an inventory number), characteristics of the matching vehicle, etc. The confirmation may also provide examples of past discounts or prices that have been awarded so as provide an incentive for the customer to visit the identified dealer and continue with the purchase of the vehicle. The confirmation may further include additional special offers to encourage the customer to proceed with the purchase. For example, the confirmation may include special offers, such as additional discounts on the price, improved financing options, upgrade or providing of vehicle accessories at no cost, etc. Such additional discounts may be contingent on one or more factors, such as whether the customer proceeds to the dealership to purchase the vehicle by a certain predetermined date or time. Further, the confirmation may include an expiration date at which the discount price may expire. Optionally, the confirmation may include a vehicle identification number (“VIN”) of the matching vehicle. The customer may then store, print out, etc. the confirmation and subsequently visit the dealership that has the vehicle desired by the customer.

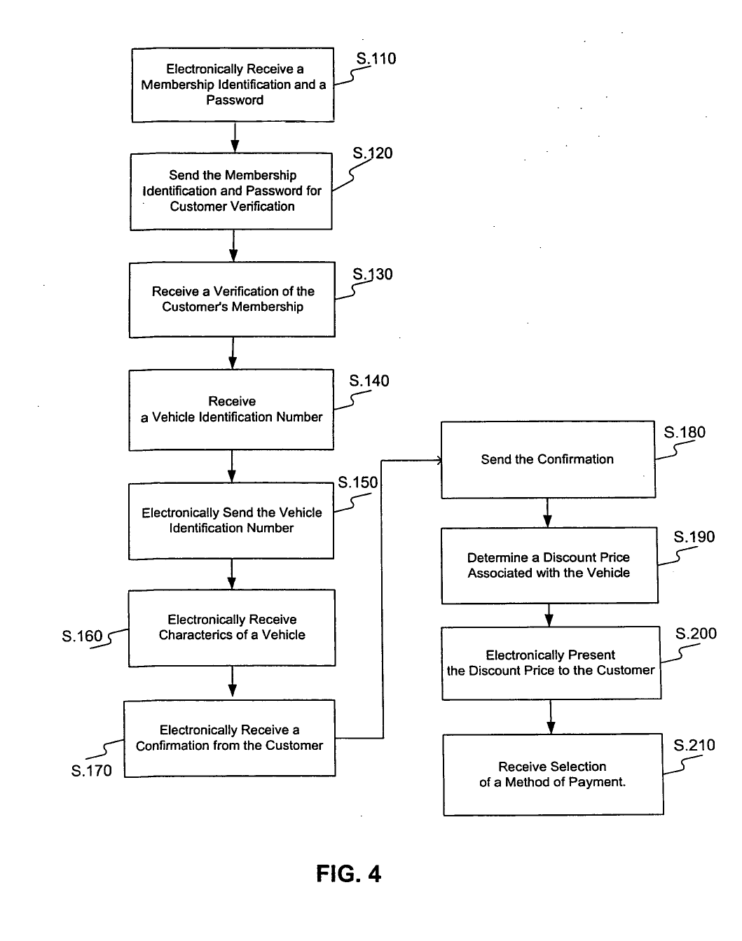

FIG. 4 illustrates a flowchart of an exemplary process for providing a discounted price for a vehicle after the customer has arrived at a dealership identified by the buying system 100 (cf. FIG. 3). Although the steps of the discounted pricing process are described as being performed in a particular order, one skilled in the art will appreciate that these steps may be performed in a modified or different order, or in an embodiment utilizing less than all of the steps described below. Further, one or more of the steps in FIG. 4 may be performed concurrently or in parallel.

First, a membership ID and a password associated with the customer are electronically received at dealer system 410 (Step S.110). For example, after arriving at the dealership indicated on the confirmation, the customer may provide the dealer with the confirmation and the dealer may show the customer the vehicle indicated on the confirmation. The customer may then verify that the vehicle shown is indeed the type of vehicle desired by the customer and/or physically inspect the same. If the vehicle is the type desired by the customer, the customer can obtain a VIN associated with the vehicle. Alternatively, the customer may desire a different vehicle offered by the dealer and can obtain a VIN associated with the different vehicle. Then, the customer and/or the dealer can access a web page or secure page hosted by computing platform 110. Such access can be facilitated by a kiosk or computer terminal at the dealership, either of which may be provided as part of dealer system 410. With such equipment, the customer inputs a membership identification and password into dealer system 410. Alternatively, the dealer may input a membership identification and password to access web page and/or secure web page, in order to confirm that the customer has arrived at the dealership. Subsequently, dealer system 410 sends the identification and password to computing platform 110 in order to verify membership status of the customer (Step S.120). Dealer system 410 may also send the identification and password associated with the dealer.

Next, dealer system 410 receives a verification of the customer's membership status (Step S.130). After computing platform 110 receives the customer's identification and password, computing platform 110 verifies the customer's membership. Computing platform 110 may compare the identification and password with data stored in customer database 140. If computing platform 110 determines that the customer is not a member, the computing platform 110 can request dealer system 410 to request the customer to re-enter the customer's identification and/or password or otherwise the process may be aborted. Similarly, computing platform 110 may verify the dealer's membership by comparing the received dealer's identification and password with data stored in dealer database 160. Computing platform 110 can also request the dealer to re-enter the dealer's identification and/or password if a match is not found.

Then dealer system 410 receives the VIN associated with the desired vehicle (Step S.140). For example, the customer can input the VIN using a kiosk, a computer terminal and/or any known input mechanism, such as a text box on a graphical user interface. Dealer system 410 then sends the entered VIN to computing platform 110 (Step S.150) and, in response, receives characteristics of the vehicle associated with the VIN (Step S.160). As part of these steps, computing platform 110 can query vehicle database 150 to find characteristics of the vehicle associated with the VIN. After obtaining the corresponding vehicle characteristics, dealer system 410 presents the characteristics to the customer at the dealership via the web page. Dealer system 410 may then display the characteristics to the customer.

Dealer system 410 may then receive a confirmation from the customer that the proper VIN was entered (Step S.170). For example, the customer may verify the accuracy of the displayed vehicle characteristics information and confirm that the proper vehicle has been selected. After receiving confirmation from the customer, dealer system 410 sends the confirmation to computing platform 110 (Step S.180) and receives a price associated with the selected vehicle (Step S.190). In an alternate embodiment, the process may skip Steps S.170 and S.180 and provide dealer system 410 with the price associated with the selected vehicle (Step S.190) upon receipt of the VIN. As discussed above, dealer database 160 may keep a record of all agreements between each financial institution and the various dealers regarding predetermined discount or preferred prices that particular vehicles may be sold for. For instance, the financial institution and the dealership where the customer is purchasing the vehicle may have a pre-negotiated agreement concerning the discounted pricing for vehicles, including the vehicle having the VIN entered by the customer. Such pricing agreements may represent a “haggle free” price that is guaranteed for all customers referred to the dealer by the financial institution. For example, if the vehicle is a new vehicle, the price may be fixed at a certain amount over the invoice price or priced at a certain percentage below a manufacturer's suggested retail price (MSRP) for customer's referred to the dealer by the financial institution. Alternatively, the price may be determined as a predetermined percentage of the true market value price for the particular make and model, as suggested by a third party, such as Edmunds.com, Inc.

The agreement may also include a predetermined fee that the dealer may provide to the financial institution for each customer referred to the dealer by the financial institution. For example, the agreement between the financial institution and the dealer may indicate that the dealer will provide $150 for each customer referred to the dealer by the financial institution. A skilled artisan will appreciate that any variety of discount prices and referral fees may be used in embodiments consistent with the present invention. Additionally, the discount price and referral fee can be determined or updated by considering various factors over time that affect pricing determinations, such as number of referrals, cost of referrals, profit margins, length of relationships, sales forecasts, time of year, location, inventory goals, etc.

For example, in one embodiment, a pricing model can be developed over time by analyzing and testing the results of various combinations and permutations involving the factors discussed above. For example, data regarding the above-mentioned factors stored in dealer database 160 can be collected from dealers that have been found to provide profitable relationships for the financial institution, and using multivariate regression analysis, predictive pricing models can be developed to enable the prediction of the best pricing and referral fees for any future agreements with dealers or re-evaluation of past agreements. For instance, after a multivariate regression model identifies the most predictive factors for determining profitability of dealers, it can create a profitability model formula including only the identified factors. The formula can weigh each identified factor to minimize the error in generating a predictive profitability score for dealers. For example, the multivariate logistic regression model may, by using regression techniques well known in the art, weigh the most predictive of the identified factors more heavily than the least predictive of the identified factors.

Also, the weights may account for differences in the types of data analyzed. For example, the formula can allow percentages, probabilities, numbers, and/or dollar amounts to be entered simultaneously. A small number, such as a probability (ranging from 0-1) may be weighed more heavily than a large number, such as revenue, to account for the different data types. Although the multivariate logistic regression model described herein initially determines the weights, one skilled in the art can appreciate that the weights may be modified later to comply with experimental results or other personal experience, for example.

After generating the formula, computing platform 110 can create a profitability grid using the historical dealer data. To accomplish this, computing platform 110 can use the determined weighted combination of factors to determine the profitability score for each dealer in the historical dealer data. Computing platform 110 then can generate a profitability grid by dividing these profitability score determinations into a predeermined number of groups. For example, the determined profitability scores may be divided into five groups, each group receiving a group score ranging from a score of 1 (low) to 5 (high). In a preferred embodiment, computing platform 110 can determine the range of profitability scores for each group according to the percentage of dealers that fall within that range. For example, the range of determined profitability scores containing the highest 20% of the determined profitability scores receives a group score of five (5). The range containing the next highest 20% of the profitability score determinations receives a group score of four (4,) etc. One skilled in the art can recognize that other scoring methods are possible. The formula and profitability grid may then be used to determine the discounted price and referral fee for a particular dealer. More particularly, computing platform 110 may enter the identified factors associated with a dealer into the formula to determine the profitability score of the dealer. Computing platform 110 then may use the profitability grid to determine a group score (e.g., 1-5) for the dealer based on the determined profitability score.

The computing platform 110 then can make a determination about the discounted price and/or referral fee based on the score. For instance, for a dealer found to have a group score of five (5) and considered to provide a profitable relationship to the financial institution, computing platform 110 may determine that a low referral fee and/or a higher discount price can be established. On the other hand, if the dealer has a lower group score, such as four (4), then computing platform 110 may determine that a higher referral fee and/or lower discounted price may be required. Moreover, the discounted price and/or referral fee may be established based on the creditworthiness of the customer. For instance, for a customer found have a good credit record, a greater discount price and/or higher referral fee may be given. Alternatively, for a customer with a negative credit history, a lower referral fee and/or smaller discount price may be given.

Returning to FIG. 4, dealer system 410 then presents the customer the predetermined price via, for example, a graphical user interface or a web page (Step S.200). The customer can then decide whether to purchase the vehicle at the discounted price. If the customer decides to purchase the vehicle, then dealer system 410 can receive the customer's selection for the method of payment (Step S.210). For instance, the customer can choose to pay for the vehicle with cash, check, credit card, and/or other payment, etc. Alternatively, the customer may also request financing for the vehicle purchase. For example, the customer may request that the financial institution provide an auto loan to cover the purchase of the vehicle. If the customer decides not to purchase the vehicle, the customer can input such into dealer system 410 without incurring a fee. Dealer system 410 may then send data regarding the customer's decision to computing platform 110.

Embodiments consistent with the principles of the present invention facilitate the purchasing of products, such as vehicles for customers. Further, the embodiments provide incentives to these customer to purchase products by providing guaranteed discount or preferred pricing to the customers and/or additional special offers, such as preferred financing, if the customer visits a dealer selling the requested product. Moreover, embodiments of the invention improve the likelihood of receiving referral fees by not disclosing the price of products to the customers until they arrive at the dealers.

Other embodiments of the invention will be apparent to those skilled in the art from consideration of the specification and practice of the invention disclosed herein. It is intended, therefore, that the specification and examples be considered as exemplary only, with a true scope and spirit of the invention being indicated by the following claims.

1. A computer-implemented method for providing an offer for a vehicle desired by a customer at a discounted price, comprising:
receiving a vehicle request from the customer including characteristics of the vehicle desired by the customer and a location associated with the customer;
electronically transmitting contact data associated with the customer to a dealer associated with the vehicle desired by the customer; and
electronically sending a confirmation of an offer to provide the desired vehicle at the discounted price to the customer, wherein the confirmation does not include pricing information associated with the vehicle.

2. The method of claim 1, wherein the confirmation includes directions to the dealer associated with the vehicle desired by the customer.

3. The method of claim 1, further comprises sending a reservation request to the dealer associated with the vehicle desired by the customer.

4. The method of claim 1, wherein the confirmation includes an incentive to encourage the customer to visit the dealer.

5. The method of claim 1, wherein the vehicle request is received by a financial institution.

6. The method of claim 5, wherein the dealer and the financial institution have an established relationship.

7. The method of claim 4, further comprising:
providing the pricing information associated with the vehicle when the customer is present at the dealer.

8. A computer-implemented method for providing a discount price for a vehicle desired by a customer, comprising:
receiving a vehicle identification number associated with the vehicle at a dealer;
electronically sending the vehicle identification number over a network;
electronically receiving data reflecting characteristics of the vehicle;
electronically receiving a confirmation from the customer;
sending the confirmation over the network;
receiving data reflecting the discount price for the vehicle;
electronically presenting the data reflecting the discount price to the customer; and
receiving a selection of a method of payment for purchasing the vehicle at the discount price from the customer.

9. The method of claim 8, wherein the vehicle identification number is sent to a financial institution.

10. The method of claim 9, wherein the financial institution and the dealer have an established relationship.

11. The method of claim 10, wherein the discount price is predetermined based on the established relationship.

12. The method of claim 9, wherein the financial institution is given a referral fee by the dealer.

13. The method of claim 9, wherein the discount price is determined based on a pricing model using multivariate regression analysis.

14. The method of claim 8, wherein the method of payment includes obtaining an auto loan.

15. The method of claim 9, wherein the method of payment includes obtaining an auto loan from the financial institution.

16. A computer-implemented system for providing an offer for a vehicle desired by a customer at a discounted price, comprising:
means for receiving a vehicle request from the customer including characteristics of the vehicle desired by the customer and a location associated with the customer;
means for electronically transmitting contact data associated with the customer to a dealer associated with the vehicle desired by the customer; and
means for electronically sending a confirmation of an offer to provide the desired vehicle at the discounted price to the customer, wherein the confirmation does not include pricing information associated with the vehicle.

17. The system of claim 16, wherein the confirmation includes directions to the dealer associated with the vehicle desired by the customer.

18. The system of claim 16, further comprises means for sending a reservation request to a dealer associated with the vehicle desired by the customer.

19. The system of claim 16, wherein the confirmation includes an incentive to encourage the customer to visit the dealer.

20. The system of claim 16, wherein the vehicle request is received by a financial institution.

21. The system of claim 20, wherein the dealer and the financial institution have an established relationship.

22. The system of claim 19, further comprising:
means for providing the pricing information associated with the vehicle when the customer is present at the dealer.

23. A computer-implemented system for providing a discount price for a vehicle desired by a customer, comprising:
means for receiving a vehicle identification number associated with the vehicle at a dealer;
means for electronically sending the vehicle identification number over a network;
means for electronically receiving data reflecting characteristics of the vehicle;
means for electronically receiving a confirmation from the customer;
means for sending the confirmation over the network;
means for receiving data reflecting the discount price for the vehicle;
means for electronically presenting the data reflecting the discount price to the customer; and
means for receiving a selection of a method of payment for purchasing the vehicle at the discount price from the customer.

24. The system of claim 23, wherein the vehicle identification number is sent to a financial institution.

25. The system of claim 24, wherein the financial institution and the dealer have an established relationship.

26. The system of claim 25, wherein the discount price is predetermined based on the established relationship.

27. The system of claim 24, wherein the financial institution is given a referral fee by the dealer.

28. The system of claim 24, wherein the discount price is determined based on a pricing model using multivariate regression analysis.

29. The system of claim 23, wherein the method of payment includes obtaining an auto loan.

30. The system of claim 24, wherein the method of payment includes obtaining an auto loan from the financial institution.
